(19) United States
(12) Patent Application Publication
(10) Pub. No.: US 2014/0197173 A1
(43) Pub. Date: Jul. 17, 2014

(54) EZ-TRAY COVER (PAINT TRAY COVER)

(71) Applicant: Francisco Juan Morla, Guaynabo, PR (US)

(72) Inventor: Francisco Juan Morla, Guaynabo, PR (US)

(21) Appl. No.: 13/739,823

(22) Filed: Jan. 11, 2013

(51) Int. Cl. B05C 21/00; B65D 25/14

(52) U.S. Cl. CPC B05C 21/00; B65D 25/14
USPC 220/495.02

(57) ABSTRACT

A cover 1 is made of a flexible plastic material similar to a plastic garbage bag, it has an expandable elastic band 4 sewn onto the circumference of the cover 1 back side (FIG. 4) and a perforation 2 (a hole) the size of a US dime (diameter 17.91 mm) in the middle of the front side (FIG. 1) which is covered with a self adhesive detachable tape 3. The self adhesive detachable tape a have four comers rounded and is located o the side that is adjacent to the tray, back side. The cover 1 has an ova: shape before it is expanded (FIG. 1). Once it is expanded, it may be adapted to contain any nine (9) inch roller paint tray (FIG. 8-10). It is used so the paint can be poured directly onto the cover (FIG. 11) and once you are done painting the self adhesive detachable tape is peeled off and any unused paint is poured back into the paint can (FIG. 12), avoiding any additional mess.

This application is an improvement of the previous application Ser. No. 12/831,191 filed Jul. 6, 2010

### SPECIFICATION

The invention is a cover 1 to be used on a nine (9) inch roller paint tray. FIG. 8-10 it will be fabricated of a flexible plastic material (similar to a polyethylene plastic bag) in black, white or transparent color. The size of the cover is:

Frontal side view: nineteen (19) inches, vertical and sixteen (16) inches, horizontal. FIG. 1

Backside view: Each of the two (2) vertical sides are three and a half (3½) inches wide and each of the two (2) horizontal sides are two and a half (2½) inches wide. There is an opening in the middle of the cover of twelve (12) inches from elastic to elastic vertical and eleven (11) inches from elastic to elastic horizontal. FIG. 3

The circumference vertical width FIG. 2 is a total of twenty six (26) inches elastic to Elastic. On frontal side view FIG. 1 nineteen (19) inches vertical and from the backside view FIG. 3, each vertical side has three and a half (3½) inches.

The circumference horizontal width FIG. 2 is a total of twenty one (21) inches elastic to Elastic. On the frontal side view FIG. 1 sixteen (16) inches horizontal and from the backside view FIG. 3, each horizontal side has two and half (2½) inches.

The extremities are gathered by an elastic band 4 that is sewn onto the circumference of the cover 1 backside similar to the one used on a shower cap) FIG. 4. In the middle of the cover 1 there is a perforation 2 (a hole) the size of a US dime (diameter 17.91 mm) FIG. 7, which is covered from the backside with a self adhesive detachable tape 3 FIG. 5. The self adhesive detachable tape 3 has four corners rounded and is located on the side that is adjacent to a tray, backside FIG. 3; and is adhered to the cover 1. The size of the self adhesive detachable tape 3 is one and a half inches (1½) vertical and one and a half inches (1½) horizontal. The purpose of the perforation 2 (a hole) is to drain the remaining paint on the cover 1 back into the can of paint.

### BACKGROUND OF INVENTION

The invention was borne because consumers like me have to invest too much time and effort into the cleanup process that the task of painting involves. Additional time is invested in the washing of the paint tray, the cleaning of the mess that occurs due to the splashing of remaining paint and other related situations. Also, the cost incurred due to losing the remaining paint in the procedure and other related costs (like water). If you are going to paint with different colors this invention facilitates the time and money that you want to invest in this task. Since there is currently no product available in the market that will fulfill this need or facilitate the press was motivated to design a cover to fit any nine (9) inch roller paint tray.

### BRIEF SUMMARY OF THE INVENTION

The invention is a cover made of a flexible plastic material for use in a nine (9) inch roller paint tray. The cover is made so that the user can conveniently adapt it onto the nine (9) inch roller paint tray, since the extremities of the cover (backside) unite with an elastic band. When the painting is over and it is time to wrap up, the process will become “EZ”. The extremities of the cover are joined towards the other direction forming a sort of cone shape. At this point you are benefiting from the time and mess that the cleaning up process entails. Also, for the paint remaining in the cover now at the tip of the cone shape, a self adhesive detachable tape was designed. It's “EZ”, the consumer can conveniently peel off the self adhesive detachable tape and empty the remaining paint directly into the paint can, resulting in a savings related to the time and the amount of product used in the process. The cover is convenient and designed to make the task of painting easier for the user.

### BRIEF DESCRIPTION OF THE SEVERAL VIEWS OF THE DRAWINGS

FIG. 1 This drawing displays the frontal side view of the cover. An oval shape cover with a perforation (a hole) located in the middle is observed.

FIG. 2 This drawing displays the cover circumference. The backside view, side view, the elastic band sewn onto the circumference of the cover and the self adhesive detachable tape are observed.

FIG. 3 This drawing displays the backside view of the cover. The elastic band sewn onto the circumference of the cover and the self adhesive detachable tape are observed.

FIG. 4 This drawing displays a partial view of the extremities of the cover with the elastic band sewn onto the circumference.

FIG. 5 This drawing displays the self adhesive detachable tape attached on the backside of the cover and is used to cover up the perforation (a hole) designed to drain paint.

FIG. 6 This drawing displays the self adhesive detachable tape attached on the backside of the cover and illustrate the direction in which the self adhesive detachable tape should be lifted. A perforation (a hole) is observed once the self adhesive detachable tape is lifted.

FIG. 7 This drawing displays a perforation (a hole) located In the middle of the cover once the self adhesive detachable tape is removed.

FIG. 8 This drawing displays the side view of the cover extended before placing on to a nine (9) inch roller paint tray. The elastic band is expanded to fit the tray.

FIG. 9 This drawing displays a side view of the cover on a nine (9) inch roller paint tray. The elastic band is expanded to contain the tray.

FIG. 10 This drawing displays the cover on a nine (9) inch roper paint tray. The frontal side view of the cover is observed on the nine (9) inch roller paint tray. A perforation (a hole) is observed and the perforated lines around the hole is displayed to indicate there is a self adhesive detachable tape located on the backside of the cover that is adjacent to the tray.

FIG. 11 This drawing displays the cover on a nine (9) inch roller paint tray. The frontal side view of the cover is observed. The drawing illustrates the utilization of the cover during the initial process when pouring the paint onto the cover.

FIG. 12 This drawing displays the cover when removed from a nine (9) inch roller paint tray and displays the utilization of the cover during the final process when pouring the remaining paint from the cover back to the paint can.

Oath

The Oath Form PTO/SB/01 is attached to this paper.

### DETAIL DESCRIPTION OF THE INVENTION

Product

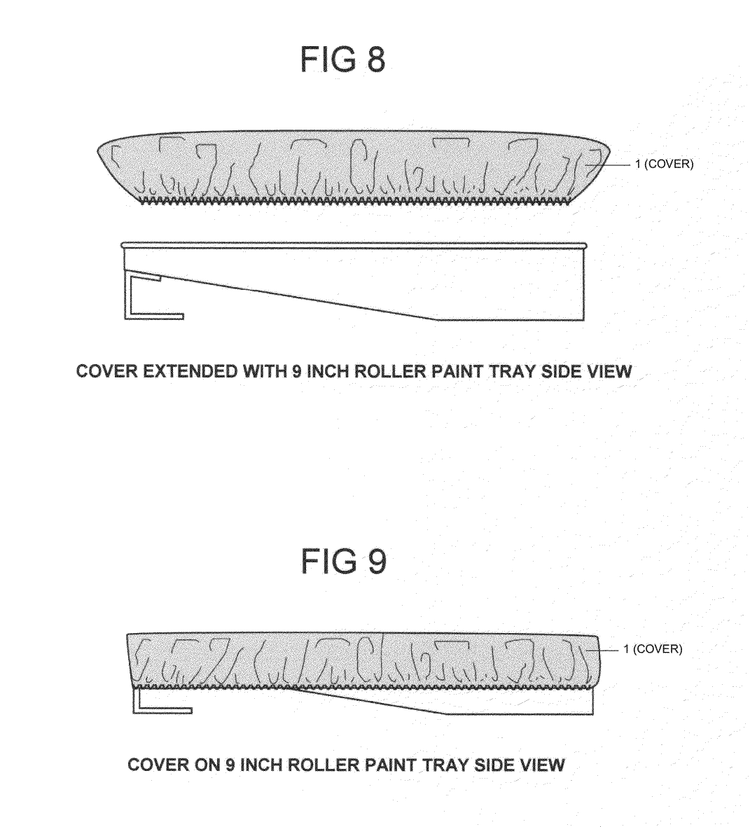

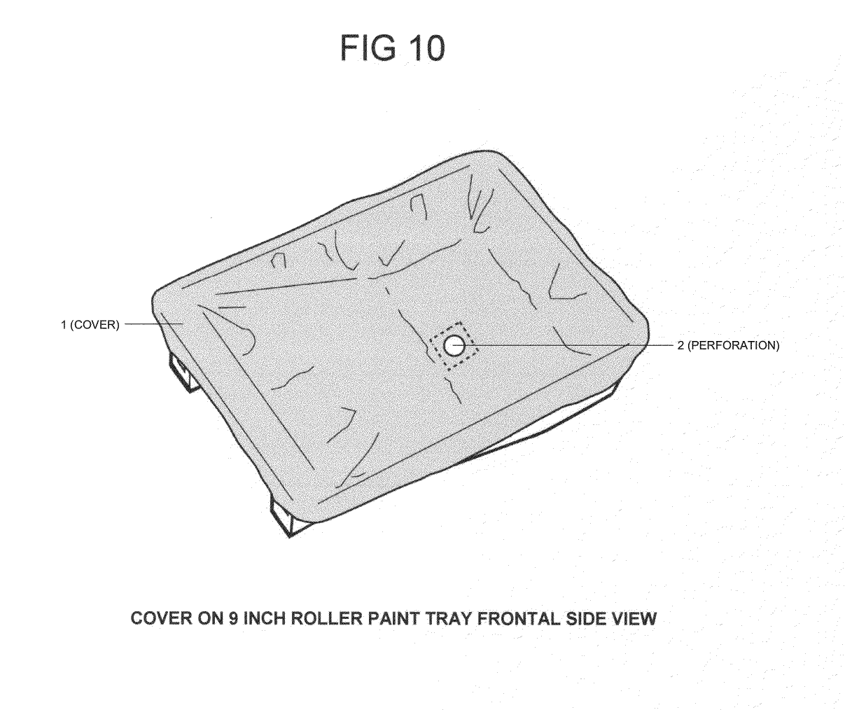

The invention is a cover 1 to be used on a nine (9) inch roller paint tray. FIG. 8-10 It will be fabricated of a flexible plastic material (similar to a polyethylene plastic bag) in black, white or transparent color. The size of the cover is:

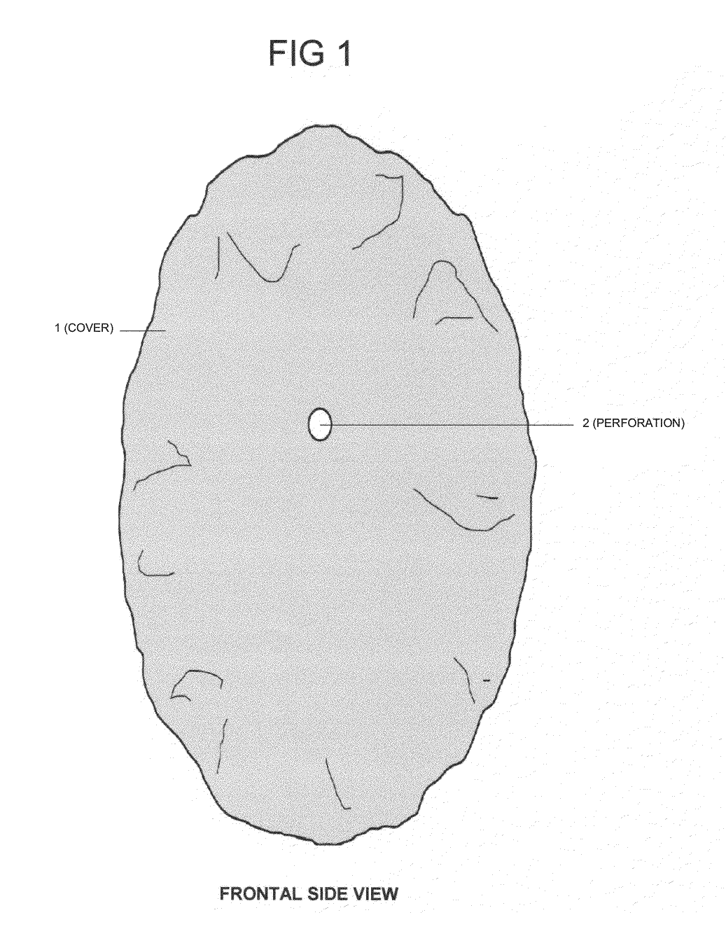

Frontal side view: nineteen (19) inches, vertical and sixteen (16) inches, horizontal. FIG. 1.

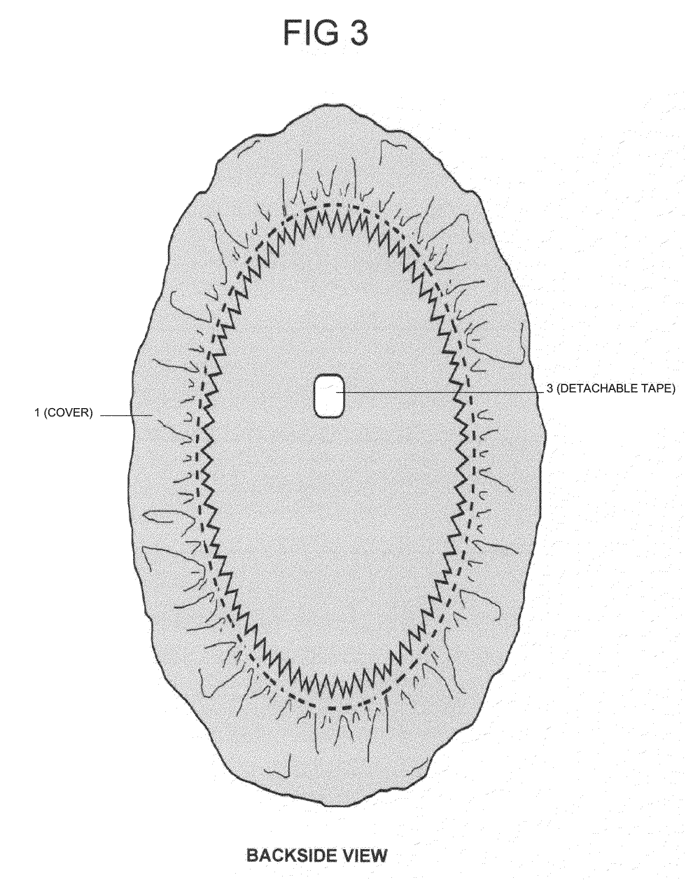

Backside view: Each of the two (2) vertical sides are three and a half (3½) inches wide and each of the two (2) horizontal sides are two and a half (2½) inches wide. There is an opening in the middle of the cover of twelve (12) inches from elastic, to elastic vertical and eleven (11) inches from elastic to elastic horizontal. FIG. 3

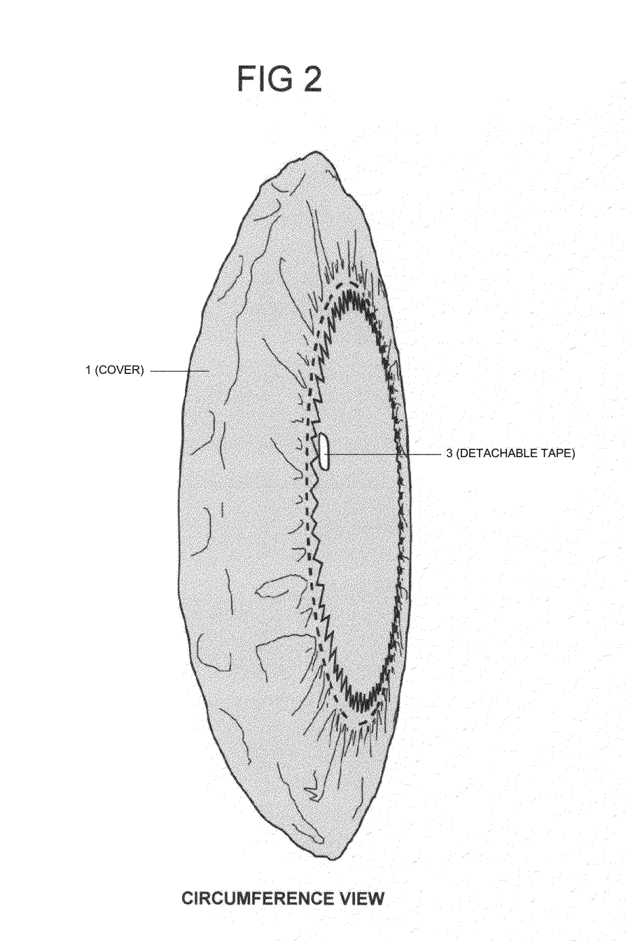

The circumference vertical width FIG. 2 is a total of twenty six (28) inches elastic to elastic: On frontal side view FIG. 1 nineteen (19) inches vertical and from the backside view FIG. 3, each vertical side has three and a half (3½) inches.

The circumference horizontal width FIG. 2 is a total of twenty one (21) inches elastic to elastic: On the frontal side view F1G. 1 sixteen (16) inches horizontal and from the backside view FIG. 3, each horizontal side has two and half (2½) inches.

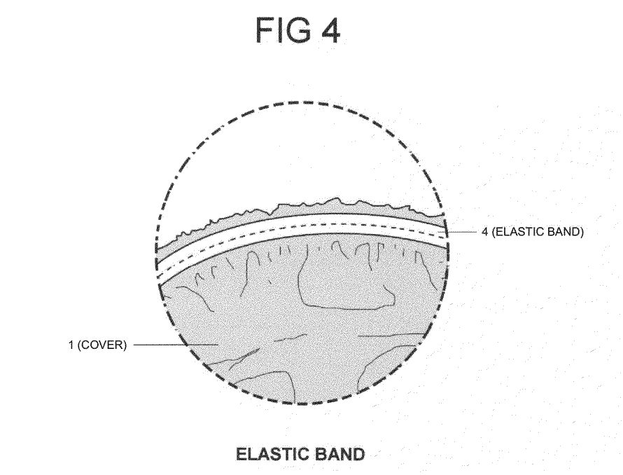

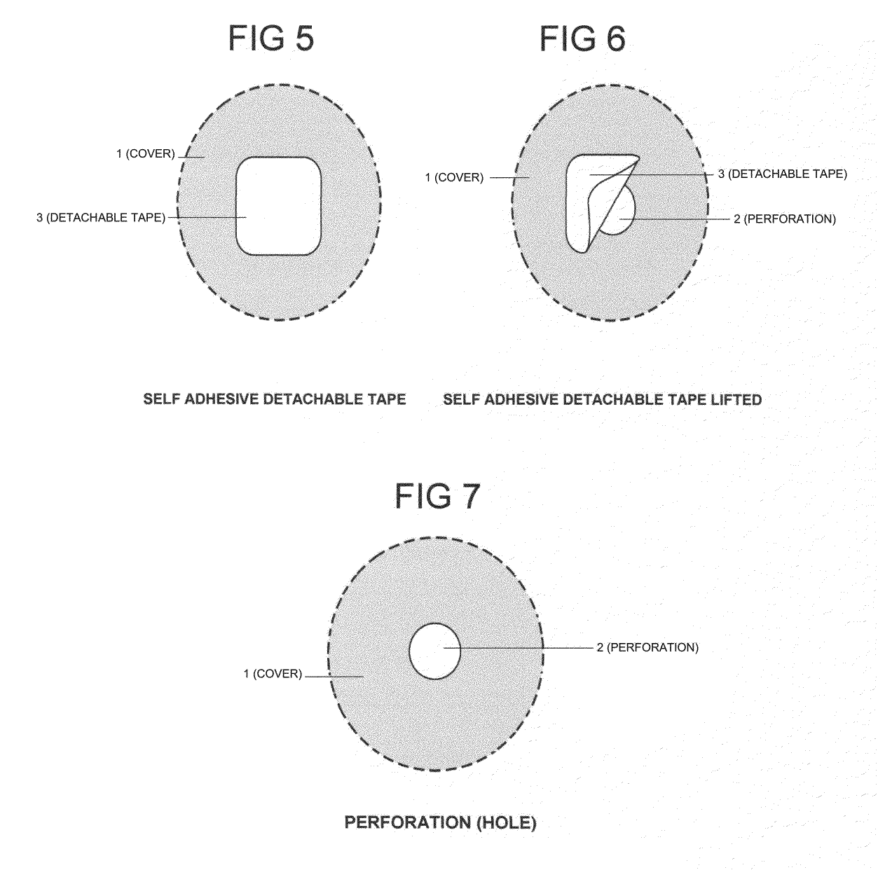

The extremities are gathered by an elastic band 4 that is sewn onto the circumference of the cover 1 backside (similar to the one used on a shower cap) FIG. 4. In the middle of the cover there is a perforation 2 (a hole) the size of a US dime (diameter 17.91 mm) FIG. 7, which is covered from the backside with a self adhesive detachable tape 3 FIG. 5. The self adhesive detachable tape 3 has four corners rounded and is located on the side that is adjacent to a tray, backside FIG. 3; and is adhered to the cover 1. The size of the self adhesive detachable tape 3 is one and a half inches (1½) vertical and one and a half inches (1½) horizontal. The purpose of the perforation 2 (a hole) is to drain the remaining paint on the cover 1 back into the can of paint.

The Process—How it's Used

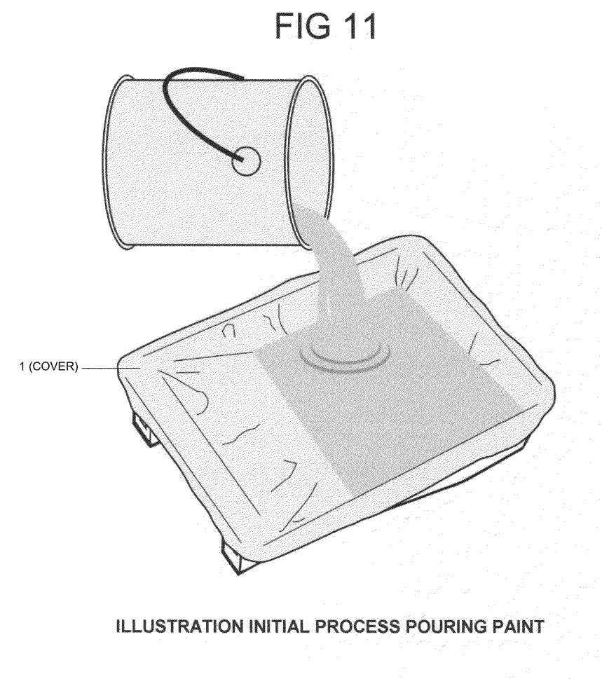

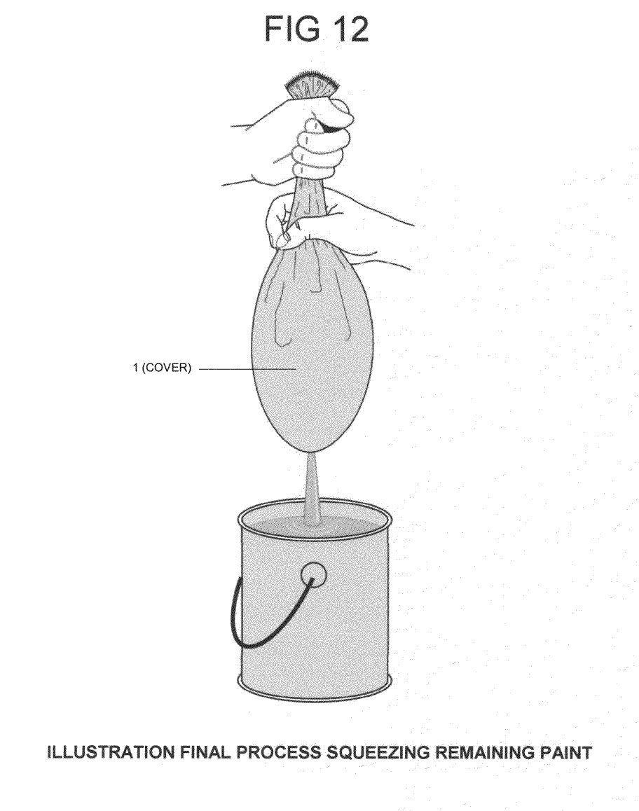

The cover is made so that the user can conveniently adapt it onto a nine (9) inch roller paint tray, since the extremities of the cover unite with an elastic band that is sewn onto the circumference of the cover. The paint is poured directly onto the cover FIG. 11 and its ready for use. When the painting job is over and it is time to wrap up, the process will become “EZ” with the use of the cover. Once you are done painting, the extremities of the cover are joined towards the other direction forming a sort of cone shape. The user should squeeze the cover from the top to the bottom toward the tip of the cone shape so that all the remaining paint settles towards the tip. At the tip of the cone shape, the user will find a self adhesive detachable tape which when lifted will allow user to empty the remaining paint back into the paint can or container FIG. 12. When you finish squeezing the remaining paint out of the cover it will be ready for disposal.

Benefits

The consumer's may benefit from the use of the “EZ-Tray Cover” in many ways since its purpose is to facilitate the process and also, save you money and time. Just some of the benefits would be the savings in the time the user is investing in completing the task of painting and the cost of the products and utilities, etc. Normally you would consider the time in washing the tray after each use and the mess this involves. Also, if you are using more than one color this time will multiply. You save in the cost of the product since the remaining paint is put back directly into the container without the mess of the spilling. Also, the savings in the water consumption and the cleaning of the areas used to wash. By using the “EZ Tray Cover”, when removed, you put a new one on and you are ready for the next job. These are just some examples but there are many other benefits, but in overall the “EZ Tray Cover” is designed to facilitate the process of painting by making it easier for the user. In today's marketplace you can probably find a variety of nine (9) inch roller paint trays but you will not find a product that offers the consumers the convenience they need like the “EZ-Tray Cover” and for the value.

What is claim:

1. A paint tray cover comprising:
A. a cover dimensioned and configured to contain a nine (9) inch roller paint tray.
B. a back side has an opining wherein said opening is of sufficient size to contain a nine (9) inch roller paint tray.
C. a back side has an elastic an that is sewn onto the circumference of the cover.
D. a cover has a perforation (a hole) in the middle of the from side.
E. a perforation is covered with a self adhesive detachable tape.
F. a self adhesive detachable tape has four corners rounded and is located on the side that is adjacent to the tray, back side.

2. The paint tray cover set forth in claim 1 wherein said the cover is made of a flexible plastic material.

3. The elastic band set forth in claim 1 wherein said expands to contain the nine (9) inch roller paint tray.

4. The perforation set forth in claim 1 wherein said has a size of a US dime (diameter 17.91 mm).

5. The self adhesive detachable tape set forth in claim 1 wherein said is adhered to cover above the perforation, in order to secure the paint in the cover.
